(19) United States
(12) Patent Application Publication
(10) Pub. No.: US 2019/0087299 A1
(43) Pub. Date: Mar. 21, 2019

(54) MEMORY SYSTEM AND METHOD

(71) Applicant: Toshiba Memory Corporation, Tokyo (JP)

(72) Inventors: Tetsuya Yasuda, Kamakura Kanagawa (JP); Fumio Hara, Kamakura Kanagawa (JP)

(21) Appl. No.: 15/896,154

(22) Filed: Feb. 14, 2018

(30) Foreign Application Priority Data
Sep. 15, 2017 (JP) 2017-177347

(51) Int. Cl. G06F 11/34; G06F 11/30; G06F 3/06; G06F 1/32

(52) U.S. Cl. CPC G06F 11/349; G06F 11/3041; G06F 1/3278; G06F 3/0658; G06F 3/0656; G06F 11/3485

(57) ABSTRACT

According to one embodiment, a memory system is connectable to a host. The memory system includes a nonvolatile first memory, and a controller circuit. The controller circuit controls to transfer data between the host and the first memory. The controller circuit measures a rate of data transfer between the host and the memory system. The controller circuit calculates a first level which is a performance level corresponding to a processing capability of the host, on the basis of the measured rate. The controller circuit operates in a first mode of controlling performance of the data transfer at the first level.

### CROSS-REFERENCE TO RELATED APPLICATIONS

This application is based upon and claims the benefit of priority from Japanese Patent Application No. 2017-177347, filed on Sep. 15, 2017; the entire contents of which are incorporated herein by reference.

### FIELD

Embodiments described herein relate generally to a memory system and a method.

### BACKGROUND

A memory system including nonvolatile memory is conventionally known. The memory system is desired to reduce power consumption while ensuring necessary performance.

### BRIEF DESCRIPTION OF THE DRAWINGS

FIG. 1 is a diagram illustrating a configuration of a memory system of an embodiment;

FIG. 2 is a schematic diagram illustrating an aspect where measured values are recorded in a ring buffer of the embodiment;

FIG. 3 is a diagram illustrating four states of the memory system of the embodiment;

FIG. 4 is a flowchart illustrating an example of operation at a startup of the memory system of the embodiment;

FIG. 5 is a flowchart illustrating an example of operation in a non-control state of the memory system of the embodiment;

FIG. 6 is a flowchart illustrating an example of operation in an active control state of the memory system of the embodiment;

FIG. 7 is a flowchart illustrating an example of operation in an idle transition state of the memory system of the embodiment;

FIG. 8 is a flowchart illustrating an example of operation in an idle control state of the memory system of the embodiment; and

FIG. 9 is a diagram illustrating an example of a transition of a performance level and a measured value of the embodiment.

### DETAILED DESCRIPTION

According to one embodiment, a memory system is connectable to a host. The memory system includes a nonvolatile first memory, and a controller circuit. The controller circuit controls to transfer data between the host and the first memory. The controller circuit measures a rate of data transfer between the host and the memory system. The controller circuit calculates a first level which is a performance level corresponding to a processing capability of the host, on the basis of the measured rate. The controller circuit operates in a first mode of controlling performance of the data transfer at the first level.

Exemplary embodiments of a memory system and a method will be explained below in detail with reference to accompanying drawings. A present invention is not limited to following embodiments.

### EMBODIMENTS

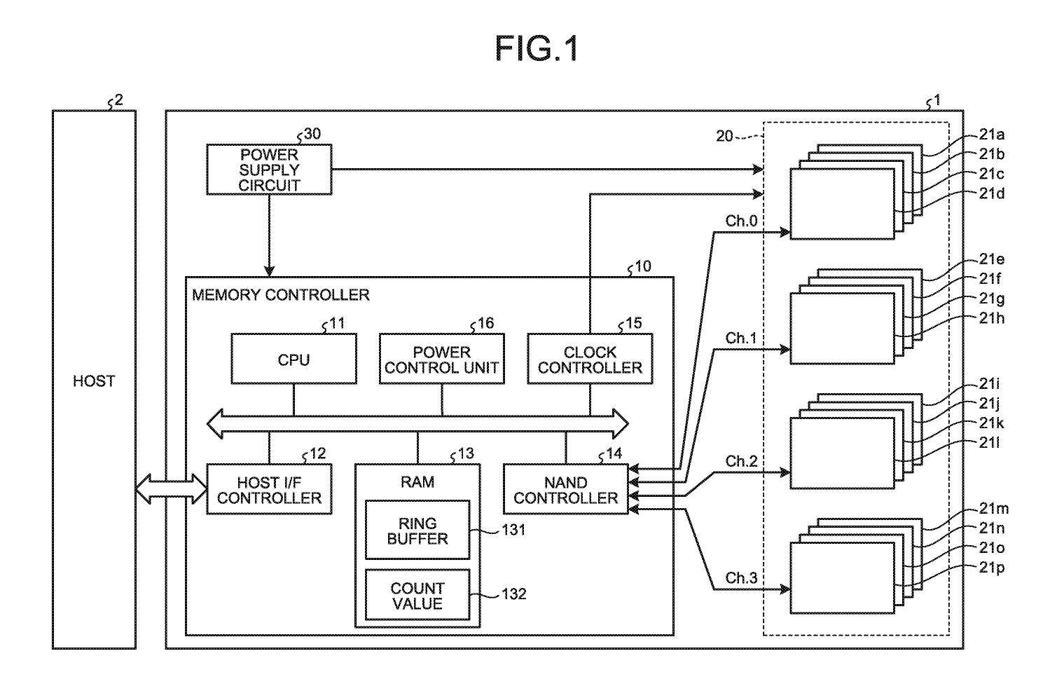

FIG. 1 is a diagram illustrating a configuration of a memory system 1 of an embodiment. The memory system 1 is connectable to a host 2. A standard applied to a communication path between the memory system 1 and the host 2 is not limited to a specific standard. SAS (Serial Attached SCSI) can be adopted as one example.

The host 2 corresponds to, for example, a personal computer, a mobile information terminal, or a server. The memory system 1 can accept access commands (a read command and a write command) from the host 2. Each access command includes a logical address indicating an access destination. The logical address indicates a location in a logical address space provided by the memory system 1 to the host 2.

The memory system 1 includes a memory controller 10, a NAND flash memory (NAND memory) 20, and a power supply circuit 30.

The NAND memory 20 is configured including one or more memory chips 21. Here, the NAND memory 20 includes 16 memory chips 21a to 21p as the one or more memory chips 21.

Each of the 16 memory chips 21 configuring the NAND memory 20 is connected to the memory controller 10 via one of four channels (ch. 0 to ch. 3), respectively. According to the example of FIG. 1, the memory chips 21a to 21d are connected to channel 0 (ch. 0). The memory chips 21e to 21h are connected to channel 1 (ch. 1). The memory chips 21i to 21l are connected to channel 2 (ch. 2). The memory chips 21m to 21p are connected to channel 3 (ch. 3).

Each channel is configured including a wire group including I/O signal lines and control signal lines. The I/O signal lines are a signal lines for transmitting and receiving, for example, data, an address, and a command. The control signal lines are signal lines for transmitting and receiving, for example, a WE (write enable) signal, a RE (read enable) signal, a CLE (command latch enable) signal, an ALE (address latch enable) signal, and a WP (write protect) signal.

The memory controller 10 can control the channels individually. The memory controller 10 controls the four channels simultaneously in parallel and accordingly can simultaneously in parallel operate four memory chips 21 in total that are connected respectively to different channels.

The number of channels provided to the memory system 1 is not limited to four. Moreover, the number of memory chips 21 connected to each channel is not limited to four.

Each memory chip 21 includes a memory cell array configuring a storage area of the NAND memory 20. Data received from the host 2 and data (such as a firmware program and management information) required to operate the memory system 1 are stored in the memory cell array.

The NAND memory 20 is an example of the nonvolatile first memory. Any type of nonvolatile memory can be adopted as the first memory. For example, a NOR flash memory, a MRAM (Magnetoresistive Random Access Memory), a ReRAM (Resistive Random Access Memory), or a PCM (Phase Change Random Access Memory) can be adopted as the first memory.

The power supply circuit 30 generates internal power to drive the memory controller 10 and the NAND memory 20, and supplies the generated internal power to the memory controller 10 and the NAND memory 20.

The memory controller 10 is a circuit that controls the entire memory system 1. For example, the memory controller 10 transfers data between the host 2 and the NAND memory 20 via a RAM (Random Access Memory) 13 described below.

The memory controller 10 includes a CPU (Central Processing Unit) 11, a host interface controller (host I/F controller) 12, the RAM 13, a NAND controller 14, a clock controller 15, and a power control unit 16. The memory controller 10 can be configured as, for example, a SoC (System-On-a-Chip). The memory controller 10 may be configured including a plurality of chips.

The NAND controller 14 is a circuit that accesses the NAND memory 20.

The clock controller 15 is a circuit that generates clocks that operate each component of the memory controller 10 and the NAND memory 20. The clock controller 15 then supplies the generated clocks to each component and the NAND memory 20.

The RAM 13 is a memory that functions as a cache, a buffer, and a working area. For example, the RAM 13 is configured of a DRAM (Dynamic Random Access Memory), an SRAM (Static Random Access Memory), or a combination thereof. The RAM 13 may be placed outside the memory controller 10.

A ring buffer 131 is provided to the RAM 13. Moreover, a count value 132 is recorded in the RAM 13. The ring buffer 131 and the count value 132 are operated by the host interface controller 12 described next.

The host interface controller 12 controls transmission and receipt of information (commands and data) between the host 2 and the memory controller 10. Especially, in an embodiment, the host interface controller 12 can measure an amount of data transfer between the host 2 and the memory system 1, and record the measured value of the amount of data transfer.

The host interface controller 12 measures the amount of data transfer (that is, a rate of data transfer) per unit time at predetermined time intervals. If a measured value is above a threshold Ta (however, Ta>0), the host interface controller 12 records the measured value in the ring buffer 131. The host interface controller 12 records a new measured value in a location where the oldest measured value has been written in the ring buffer 131. The amount of data transfer per unit time is also written as the amount of transfer of data per unit time, or the amount of data transfer.

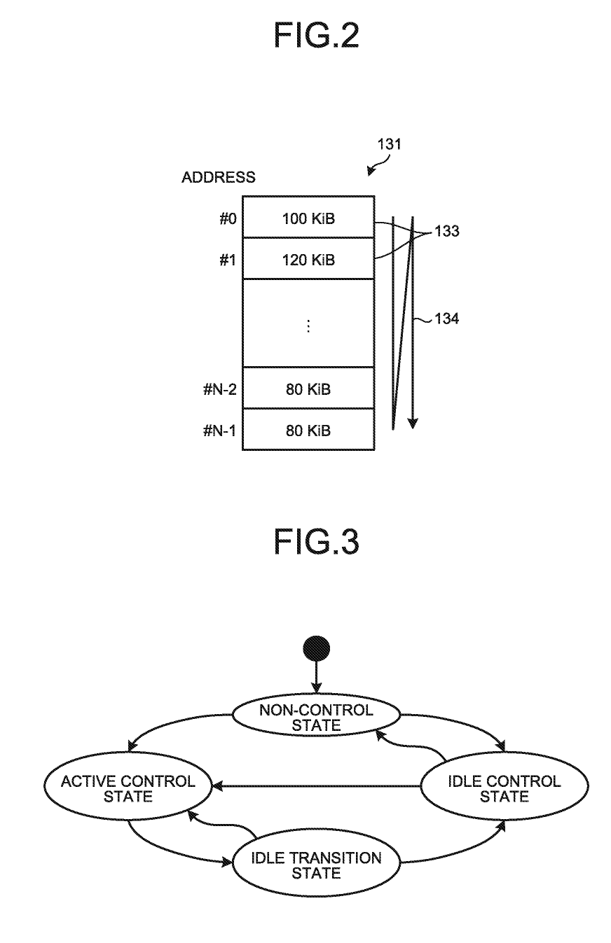

FIG. 2 is a schematic diagram illustrating an aspect where measured values are recorded in the ring buffer 131. The ring buffer 131 includes N areas 133 having consecutive addresses in FIG. 2. One measured value is stored in each area 133. Each measured value is in KiB unit in the example of FIG. 2. As indicated by an arrow 134, measured values are overwritten and stored in order of addresses into the N areas 133. After a measured value is stored in the last area 133, a next measured value is stored in the first area 133. Such a configuration allows the ring buffer 131 to retain latest N measured values among a plurality of measured values input in the ring buffer 131.

Furthermore, the host interface controller 12 can increment the count value 132 by one if the measured value is below a threshold Tb (here, Ta>Tb>0), and reset the count value 132 to zero if the measured value is not below the threshold Tb. Such an operation causes the count value 132 to correspond to a period during which the amount of data transfer per unit time is continuously below the threshold Tb.

The amount of data transfer is simply required to be measured a plurality of times at different timings. The timing to measure the amount of data transfer can be freely set. Moreover, the host interface controller 12 may measure only an amount of data transferred from the memory system 1 to the host 2, or may measure only an amount of data transferred from the host 2 to the memory system 1. It is assumed here as an example that the host interface controller 12 measures a total amount of data transferred from the memory system 1 to the host 2 and data transferred from the host 2 to the memory system 1. Moreover, the unit time can be freely set. Moreover, the host interface controller 12 may measure and regard the number of commands received per unit time as the amount of data transfer per unit time.

The CPU 11 is a processor that operates on the basis of a program (firmware program) embedded in advance in the memory system 1. The firmware program is stored in, for example, a predetermined location of the NAND memory 20. The CPU 11 loads the firmware program from the NAND memory 20 to the RAM 13 at a startup of the memory system 1. The CPU 11 then executes the firmware program loaded in the RAM 13. The CPU 11 achieves various functions of the memory controller 10 in accordance with the firmware program.

Especially, the CPU 11 controls the performance of data transfer between the host 2 and the NAND memory 20. The performance of data transfer has a correlation with power consumption of the memory system 1. For example, if the performance of data transfer is reduced, the power consumption of the memory system 1 is reduced. If the performance of data transfer is increased, the power consumption of the memory system 1 is increased. In an embodiment, four states related to control of the performance of data transfer are defined to efficiently reduce the power consumption. The states is also written as modes. In other words, the memory controller 10 can operate in four modes. The CPU 11 transitions between the states on the basis of the measured value recorded in the ring buffer 131 and the count value 132. The CPU 11 then determines a performance level according to the state.

The performance level indicates a setting value of the performance of data transfer of the memory system 1. In other words, the performance of data transfer of the memory system 1 is the performance of data transfer between the host 2 and the NAND memory 20 performed by the memory controller 10. The performance of data transfer between the host 2 and the NAND memory 20 is allowed to vary up to a ceiling of the performance level. That is, the performance level indicates an upper limit of the performance of data transfer. The performance level can be set within a range from first amount to second amount. The first amount is a maximum possible amount of data transfer in a case where the performance is reduced to the minimum level. The second amount is a maximum possible amount of data transfer in a case where the performance is not at all reduced. The performance level does not necessarily need to be expressed in the amount of data transfer. The performance level may be expressed in a normalized amount.

FIG. 3 is a diagram illustrating the four states. As illustrated in FIG. 3, a non-control state, an idle control state, an active control state, and an idle transition state are defined.

The non-control state is a state (mode) where the performance of data transfer is not at all reduced. In the non-control state, the memory controller 10 can transfer data between the host 2 and the NAND memory 20 with the maximum performance of the memory system 1. Immediately after the startup of the memory system 1, the CPU 11 sets the non-control state. In the non-control state, the CPU 11 sets the maximum value within the settable range as the performance level.

The active control state is a state (mode) where data is transferred between the host 2 and the NAND memory 20 with performance corresponding to the processing capability of the host 2. The processing capability of the host 2 is the data transfer capability of the host 2.

As an example here, the CPU 11 regards a maximum value (Tmax) of the N measured values recorded in the ring buffer 131, as the amount indicating the processing capability of the host 2, in the active control state. The CPU 11 then multiplies Tmax by a predetermined constant Const, and sets the value obtained by the multiplication as the performance level of the performance of the memory system 1. The constant Const is a value slightly greater than one (for example, 1.2). Accordingly, the performance level is set at a value obtained by adding a small margin to the processing capability of the host 2.

The method for determining the performance level in the active control state is not limited to this. For example, the CPU 11 may set a value obtained by adding a predetermined positive constant to Tmax as the performance level. Alternatively, the CPU 11 may carry out any calculation such as differentiation, integration, second differentiation, averaging, and smoothing for a predetermined number of measured values recorded in the ring buffer 131, and then calculate a performance level corresponding to the processing capability of the host 2.

The idle control state is a state (mode) where the performance is reduced to the minimum level. In the idle control state, the CPU 11 sets the minimum value within the settable range as the level value of the performance level. In other words, the memory controller 10 controls the performance of data transfer of the memory system 1 at the minimum level in the idle control state.

The idle transition state is a state (mode) that is prepared as a preparation stage leading from the active control state to the idle control state.

As illustrated in FIG. 3, the memory controller 10 can transition from the non-control state to the active control state or the idle control state. Moreover, the memory controller 10 can transition from the active control state to the idle transition state. Moreover, the memory controller 10 can transition from the idle transition state to the active control state or the idle control state. Moreover, the memory controller 10 can transition from the idle control state to the active control state. Moreover, the memory controller 10 can transition from the idle control state to the non-control state. Conditions for each transition are described below.

The CPU 11 transmits the performance level to the power control unit 16. The power control unit 16 controls the performance of data transfer at the performance level received from the CPU 11. Any method can be adopted as the method for reducing the performance of data transfer.

For example, the power control unit 16 instructs the clock controller 15 to change the frequency of a clock that is supplied to each electronic component. The power control unit 16 may change the frequency of a clock that operates the memory controller 10, or may change the frequency of a clock that operates the NAND memory 20. When the frequency of a clock supplied is reduced, the operating speed of an electronic component to which the clock is supplied is reduced, and the performance of data transfer is reduced. When the other conditions are the same, the performance of data transfer is reduced with decreasing frequency of a clock supplied to an electronic component.

In another example, the power control unit 16 changes the number of parallel operations of the NAND memory 20. According to the example of FIG. 1, the memory controller 10 controls the four channels simultaneously and accordingly can operate in parallel four memory chips 21 connected respectively to the different channels. The power control unit 16 reduces the number of channels that are simultaneously controlled from four to, for example, one to three and accordingly can reduce the number of the memory chips 21 accessed in parallel. If the other conditions are the same, when the number of the memory chips 21 accessed in parallel is reduced, the performance of data transfer is reduced.

The number of parallel operations is not limited to the number of channels that are simultaneously controlled. The power control unit 16 may switch between execution and non-execution of bank interleave. According to bank interleave, a plurality of the memory chips 21 included respectively in different channels configures one bank. For example, four memory chips 21a, 21e, 21i, and 21m configure one bank, and four memory chips 21b, 21f, 21j, and 21n configure another bank. The memory controller 10 can transmit and receive data or a command to and from the one bank while accessing the other bank. In this manner, bank interleave allows the memory controller 10 to access in parallel a plurality of the memory chips 21 belonging to the same channel. When the power control unit 16 stops bank interleave, the number of the memory chips 21 that are accessed in parallel is reduced. As a result, the performance of data transfer is reduced.

The power control unit 16 stores, for example, a table that specifies the frequency of a clock and the number of parallel operations according to each value of the performance level. According to the table, the frequency of a clock and the number of parallel operations are specified in such a manner that the performance of data transfer is increased with increasing the performance level. When having received the performance level, the power control unit 16 acquires, from the table, the frequency of a clock and the number of parallel operations corresponding to the received performance level. The power control unit 16 then sets the acquired frequency of a clock and number of parallel operations.

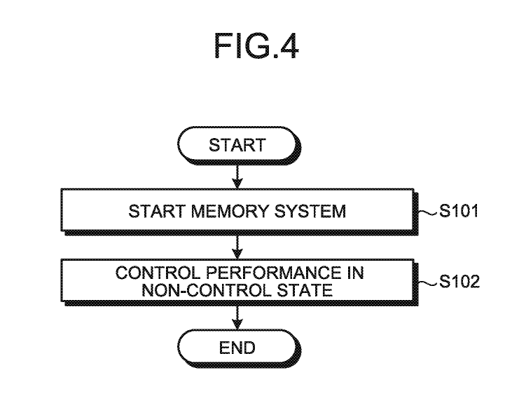

Next, the operation of the memory system 1 of an embodiment is described with reference to FIGS. 4 to 8.

FIG. 4 is a flowchart illustrating an example of the operation of the memory system 1 at startup. As illustrated in FIG. 4, when the memory system 1 is started (S101), the CPU 11 controls the performance in the non-control state (S102). The operation of setting the state immediately after startup is completed.

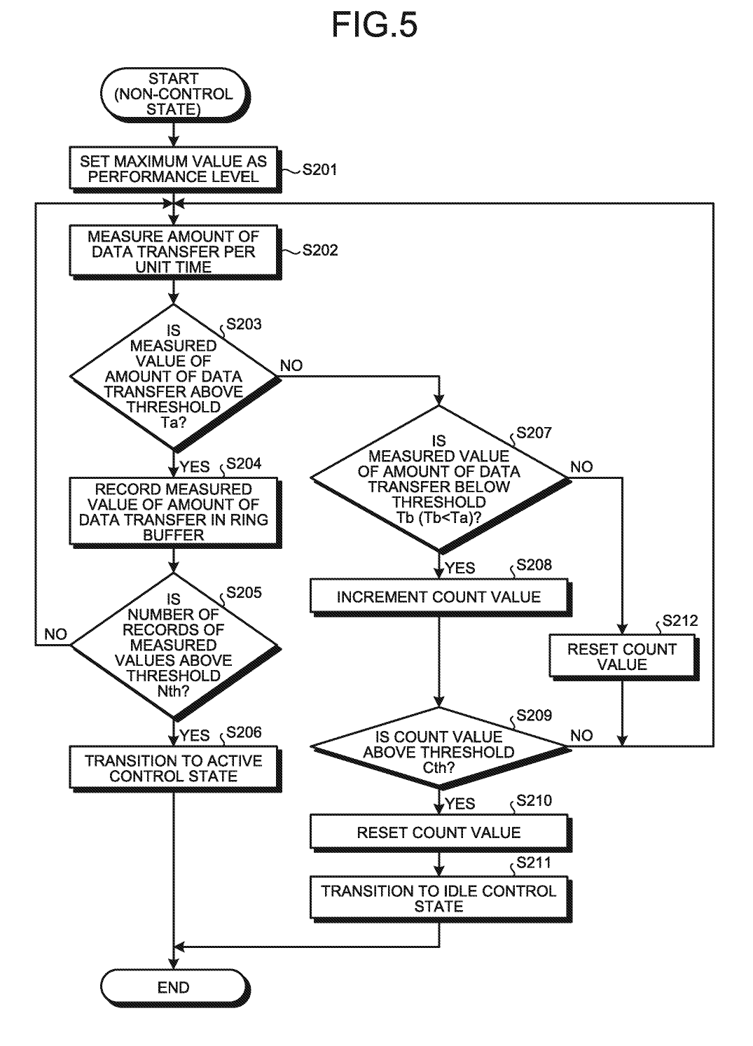

FIG. 5 is a flowchart illustrating an example of the operation of the memory system 1 in the non-control state. As illustrated in FIG. 5, in the non-control state, the CPU 11 sets the maximum value as the performance level (S201). The performance level is transmitted to the power control unit 16. The power control unit 16 controls the performance of data transfer at the performance level. In other words, the power control unit 16 maximizes the performance of data transfer. For example, the power control unit 16 sets the frequency of a clock that is supplied to each electronic component at a maximum value within a settable range, and sets the number of parallel operations of the NAND memory 20 at a maximum value within a settable range.

Next, the host interface controller 12 measures the amount of data transfer per unit time (S202). Unless the memory system 1 becomes in another state, the process of S202 is repeated at predetermined time intervals.

After the process of S202, the host interface controller 12 determines whether or not the measured value of the amount of data transfer is above the threshold Ta (S203). If the measured value of the amount of data transfer is above the threshold Ta (S203, Yes), the host interface controller 12 records the measured value in the ring buffer 131 (S204).

The CPU 11 monitors the number (the number of records) of measured values retained in the ring buffer 131. The CPU 11 determines whether or not the number of records of measured values is above a threshold Nth (S205). However, the threshold Nth is a value lower than the number (that is, N) of the areas 133 included in the ring buffer 131. If the number of records of measured values is above the threshold Nth (S205, Yes), the CPU 11 changes the state of performance control from the non-control state to the active control state (S206). The operation in the non-control state ends.

If the measured value of the amount of data transfer is not above the threshold Ta (S203, No), the host interface controller 12 determines whether or not the measured value of the amount of data transfer is below the threshold Tb (S207). If the measured value of the amount of data transfer is below the threshold Tb (S207, Yes), the host interface controller 12 increments the count value 132 by one (S208).

The CPU 11 monitors the count value 132, and determines whether or not the count value 132 is above a threshold Cth (S209). If the count value 132 is above the threshold Cth (S209, Yes), the CPU 11 resets the count value 132 to zero (S210), and changes the state of performance control from the non-control state to the idle control state (S211). The operation in the non-control state ends.

If the measured value of the amount of data transfer is not below the threshold Tb (S207, No), the host interface controller 12 resets the count value 132 to zero (S212).

If the number of records of measured values is not above the threshold Nth (S205, No), or if the count value 132 is not above the threshold Cth (S209, No), or after the process of S212, the process of S202 is executed again.

In the comparison process (S203, S205, S207, or S209), the process in a case where the threshold is equal to the amount of a comparison target (the measured value of the amount of data transfer, the number of records of measured values, or the count value) is not limited to the above description. For example, if the measured value of the amount of data transfer is equal to the threshold Ta in the determination process of S203, the memory controller 10 may execute not the process of S207 but the process of S204. Moreover, if the number of records of measured values is equal to the threshold Nth in the determination process of S205, the memory controller 10 may execute not the process of S202 but the process of S206. Moreover, if the measured value of the amount of data transfer is equal to the threshold Tb in the determination process of S207, the memory controller 10 may execute not the process of S212 but the process of S208. Moreover, if the count value 132 is equal to the threshold Cth in the determination process of S209, the memory controller 10 may execute not the process of S202 but the process of S210.

In this manner, in the non-control state, the memory controller 10 becomes in the active control state on the basis of a comparison between the measured value of the amount of data transfer and the threshold Ta. Specifically, the memory controller 10 records a measured value in the ring buffer 131 if the measured value is above the threshold Ta, and becomes in the active control state if the number of measured values recorded in the ring buffer 131 is above the threshold Nth.

Moreover, in the non-control state, the memory controller 10 becomes in the idle control state on the basis of a compassion between the measured value of the amount of data transfer and the threshold Tb. Specifically, the memory controller 10 becomes in the idle control state if all measured values obtained consecutively a predetermined number of times (that is, for a predetermined period) are below the threshold Tb.

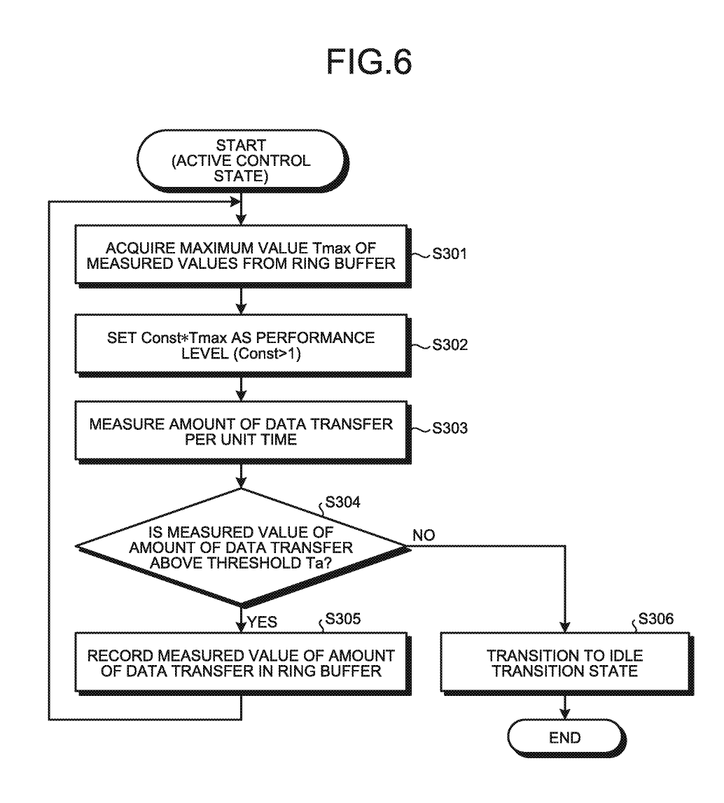

FIG. 6 is a flowchart illustrating an example of the operation of the memory system 1 in the active control state. As illustrated in FIG. 6, in the active control state, the CPU 11 acquires the maximum value (Tmax) of a plurality of measured values stored in the ring buffer 131 (S301). The CPU 11 then sets Const*Tmax as the performance level (S302). Here, Const is a constant greater than one. The performance level is transmitted to the power control unit 16. The power control unit 16 controls the performance of data transfer at the performance level.

Next, the host interface controller 12 measures the amount of data transfer per unit time (S303). Unless the memory system 1 becomes in another state, the process of S303 is repeated at predetermined time intervals.

After the process of S303, the host interface controller 12 determines whether or not the measured value of the amount of data transfer is above the threshold Ta (S304). If the measured value of the amount of data transfer is above the threshold Ta (S304, Yes), the host interface controller 12 records the measured value in the ring buffer 131 (S305). The process of S301 is then executed again.

If the measured value of the amount of data transfer is not above the threshold Ta (S304, No), the host interface controller 12 notifies the CPU 11 that the measured value of the amount of data transfer is not above the threshold Ta. The notified CPU 11 changes the state of performance control from the active control state to the idle transition state (S306). The operation in the active control state ends.

If the measured value of the amount of data transfer is equal to the threshold Ta in the determination process of S304, the memory controller 10 may execute not the process of S306 but the process of S305.

In this manner, in the active control state, the memory controller 10 becomes in the idle transition state on the basis of a comparison between the measured value of the amount of data transfer and the threshold Ta. Specifically, if the measured value of the amount of data transfer is below the threshold Ta, the memory controller 10 becomes in the idle transition state.

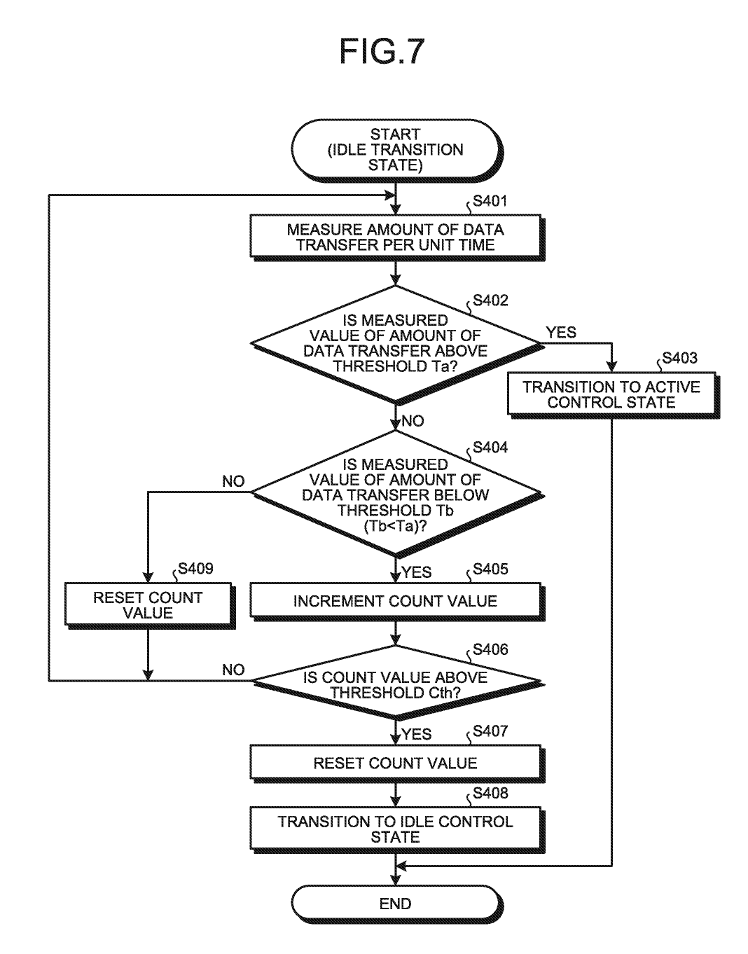

FIG. 7 is a flowchart illustrating an example of the operation of the memory system 1 in the idle transition state. As illustrated in FIG. 7, in the idle transition state, the host interface controller 12 measures the amount of data transfer per unit time (S401). The host interface controller 12 then determines whether or not the measured value of the amount of data transfer is above the threshold Ta (S402). If the measured value of the amount of data transfer is above the threshold Ta (S402, Yes), the host interface controller 12 notifies the CPU 11 that the measured value of the amount of data transfer is above the threshold Ta. The notified CPU 11 changes the state of performance control from the idle transition state to the active control state (S403). The operation in the idle transition state ends.

If the measured value of the amount of data transfer is not above the threshold Ta (S402, No), the host interface controller 12 determines whether or not the measured value of the amount of data transfer is below the threshold Tb (S404). If the measured value of the amount of data transfer is below the threshold Tb (S404, Yes), the host interface controller 12 increments the count value 132 by one (S405).

The CPU 11 determines whether or not the count value 132 is above the threshold Cth (S406). If the count value 132 is above the threshold Cth (S406, Yes), the CPU 11 resets the count value 132 to zero (S407), and changes the state of performance control from the idle transition state to the idle control state (S408). The operation in the idle transition state ends.

If the measured value of the amount of data transfer is not below the threshold Tb (S404, No), the host interface controller 12 resets the count value 132 to zero (S409). After the process of S409, or if the count value 132 is not above the threshold Cth (S406, No), the process of S401 is executed again.

If the measured value of the amount of data transfer is equal to the threshold Ta in the determination process of S402, the memory controller 10 may execute not the process of S404 but the process of S403. Moreover, if the measured value of the amount of data transfer is equal to the threshold Tb in the determination process of S404, the memory controller 10 may execute not the process of S409 but the process of S405. Moreover, if the count value 132 is equal to the threshold Cth in the determination process of S406, the memory controller 10 may execute not the process of S401 but the process of S407.

In this manner, in the idle transition state, the memory controller 10 becomes in the active control state on the basis of a comparison between the measured value of the amount of data transfer and the threshold Ta. Specifically, if the measured value of the amount of data transfer is above the threshold Ta, the memory controller 10 becomes in the active control state.

Moreover, the memory controller 10 becomes in the idle control state on the basis of a comparison between the measured value of the amount of data transfer and the threshold Tb. Specifically, if the measured value of the amount of data transfer is below the threshold Tb, the memory controller 10 becomes in the idle control state.

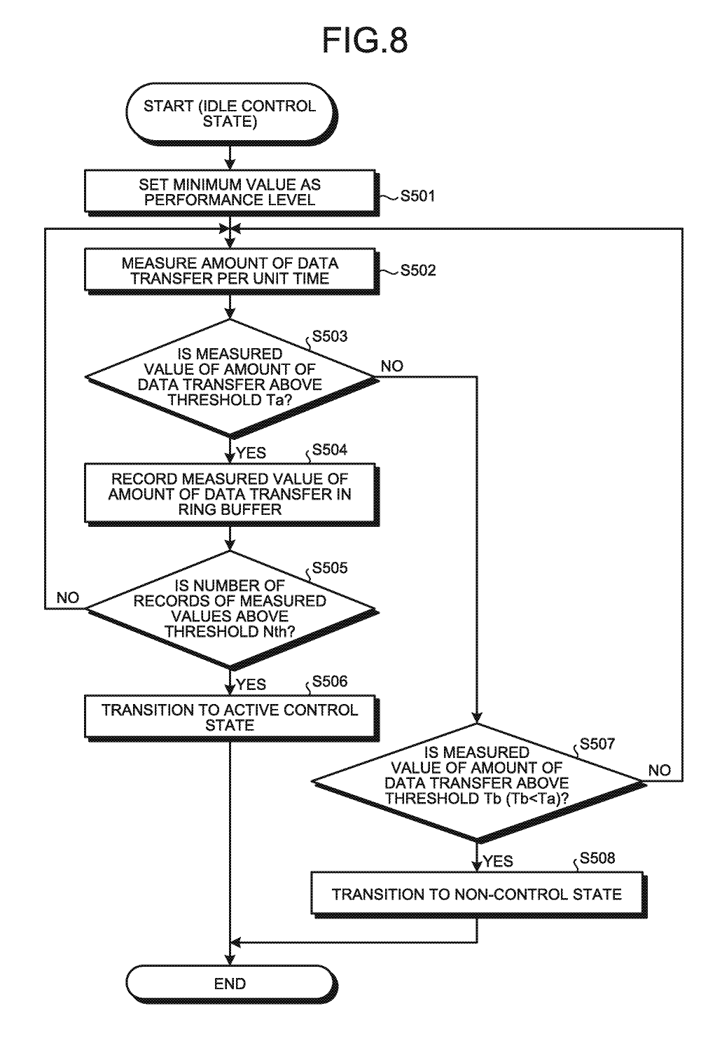

FIG. 8 is a flowchart illustrating an example of the operation of the memory system 1 in the idle control state. As illustrated in FIG. 8, in the idle control state, the CPU 11 sets the minimum value within the settable range as the performance level (S501). The performance level is transmitted to the power control unit 16. The power control unit 16 controls the performance of data transfer at the performance level.

Next, the host interface controller 12 measures the amount of data transfer per unit time (S502). The host interface controller 12 then determines whether or not the measured value of the amount of data transfer is above the threshold Ta (S503). If the measured value of the amount of data transfer is above the threshold Ta (S503, Yes), the host interface controller 12 records the measured value in the ring buffer 131 (S504).

The CPU 11 determines whether or not the number of records of measured values is above the threshold Nth (S505). If the number of records of measured values is above the threshold Nth (S505, Yes), the CPU 11 changes the state of performance control from the idle control state to the active control state (S506). The operation in the idle control state ends.

If the measured value of the amount of data transfer is not above the threshold Ta (S503, No), the host interface controller 12 determines whether or not the measured value of the amount of data transfer is above the threshold Tb (S507). If the measured value of the amount of data transfer is above the threshold Tb (S507, Yes), the host interface controller 12 notifies the CPU 11 that the measured value of the amount of data transfer is above the threshold Tb. The notified CPU 11 changes the state of performance control from the idle control state to the non-control state (S508). The operation in the idle control state ends.

If the number of records of measured values is not above the threshold Nth (S505, No), or if the measured value of the amount of data transfer is not above the threshold Tb (S507, No), the process of S502 is executed again.

If the measured value of the amount of data transfer is equal to the threshold Ta in the determination process of S503, the memory controller 10 may execute not the process of S507 but the process of S504. Moreover, if the number of records of measured values is equal to the threshold Nth in the determination process of S505, the memory controller 10 may execute not the process of S502 but the process of S506. Moreover, if the measured value of the amount of data transfer is equal to the threshold Tb in the determination process of S507, the memory controller 10 may execute not the process of S502 but the process of S508.

In this manner, in the idle control state, the memory controller 10 becomes in the active control state on the basis of at least a comparison between the measured value of the amount of data transfer and the threshold Ta. Specifically, if the measured value of the amount of data transfer is above the threshold Ta, and the number of records of measured values in the ring buffer 131 is above the threshold Nth, the memory controller 10 becomes in the active control state.

Moreover, in the idle control state, the memory controller 10 becomes in the non-control state on the basis of at least a comparison between the measured value of the amount of data transfer and the threshold Tb. Specifically, if the measured value of the amount of data transfer is above the threshold Tb, and the number of records of measured values in the ring buffer 131 is below the threshold Nth, the memory controller 10 becomes in the non-control state.

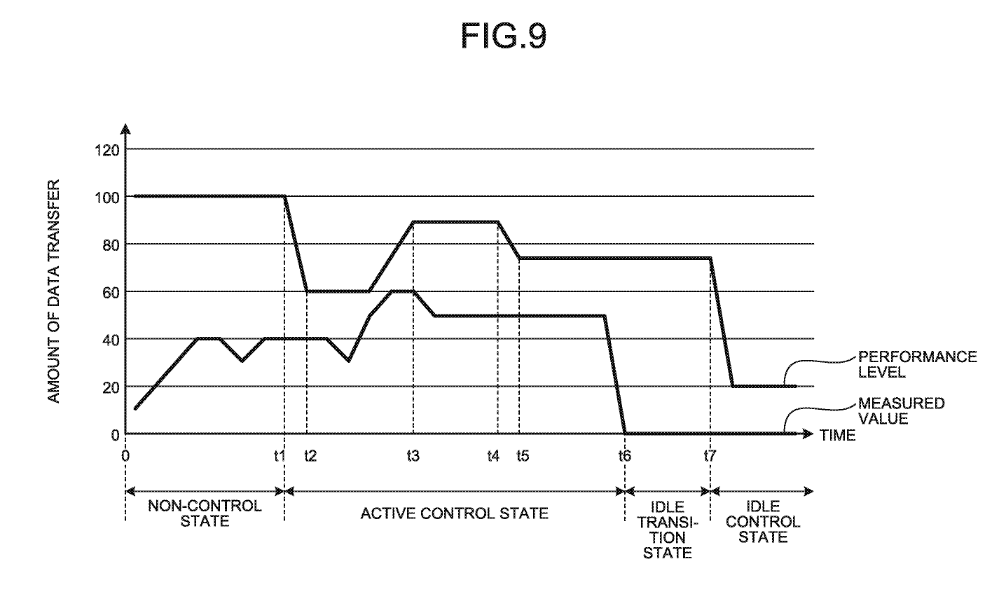

FIG. 9 is a diagram illustrating an example of the transition of the performance level and the measured value (that is, the actual amount of data transfer). The horizontal axis of FIG. 9 indicates elapsed time from startup. From immediately after startup to t1, the memory system 1 is in the non-control state. The memory controller 10 can operate with the maximum performance. Here, if the memory controller 10 exerts the maximum performance, the memory controller 10 is assumed to be able to transfer data with an amount of data transfer of “100”. In other words, from immediately after startup to t1, the performance level is fixed at “100”.

At t1, the number of records of measured values reaches the threshold Nth. Accordingly, the memory controller 10 transitions to the active control state. After the transition to the active control state, at t2, the memory controller 10 reduces the performance to a performance level (here “60”) corresponding to the actual amount of data transfer (here “40”). In other words, in the active control state, the memory controller 10 transfers data with performance higher than the processing capability of the host 2 and lower than the maximum performance of the memory controller 10.

Between t2 and t3, the performance level is raised to approximately “90” with increasing actual amount of data transfer.

After t3, the actual amount of data transfer decreases. However, in the active control state, the performance level fluctuates depending on the maximum value of the N measured values stored in the ring buffer 131. Hence, the performance level becomes constant at approximately “90” from when the actual amount of data transfer starts to decrease at time t3 to when all the N measured values are rewritten at t4. The performance level is then reduced to approximately “75” (t5).

When the actual amount of data transfer decreases to zero at t6, the memory system 1 becomes in the idle transition state. In the idle transition state, the performance level is not changed from approximately “75” being the value at the time of the transition to the idle transition state. Hence, even if the actual amount of data transfer dramatically increases in the idle transition state, the memory controller 10 can transfer data with performance of up to “75”.

After the actual amount of data transfer decreases to zero at t6, when the count value 132 reaches Cth at time t7, the memory controller 10 becomes in the idle control state. At t7, the memory controller 10 reduces the performance to the minimum performance level (here 20).

As described above, in the active control state, the memory controller 10 calculates a performance level according to the transfer capability of the host 2, and controls the performance of data transfer of the memory controller 10 at the performance level.

For example, consider a case where the processing capability of the host 2 is lower than the capability of data transfer of the memory system 1. Since the memory controller 10 has the above-mentioned configuration, the host 2 can exert the maximum processing capability against the memory system 1. On the other hand, the above-mentioned configuration allows the memory system 1 to reduce the performance thereof according to the processing capability of the host 2. Hence, the power consumption of the memory system 1 is reduced as compared to a case where the memory system 1 exerts the maximum performance. In other words, the memory system 1 can reduce the power consumption while ensuring necessary performance. Accordingly, convenience becomes high.

Moreover, the memory controller 10 has the above-mentioned configuration. Accordingly, in the active control state, the memory controller 10 can transfer data with performance lower than the maximum performance thereof and higher than the processing capability of the host 2.

Hence, the memory system 1 can reduce the power consumption while ensuring necessary performance.

Moreover, the memory controller 10 transitions from the active control state to the idle control state via the idle transition state on the basis of at least a comparison between the measured value of the amount of data transfer and the threshold Tb. The memory controller 10 controls the performance thereof at the minimum level in the idle control state.

Hence, the memory system 1 can reduce the power consumption to the minimum level when the actual amount of data transfer dramatically decrease.

Moreover, the memory controller 10 transitions from the idle control state to the active control state on the basis of at least a comparison between the measured value of the amount of data transfer and the threshold Ta.

Hence, the memory system 1 can return to the active control state when the actual amount of data transfer increases.

The memory controller 10 transitions from the active control state to the idle control state via the idle transition state. If the measured value of the amount of data transfer is below the threshold Ta in the active control state, the memory controller 10 transitions to the idle transition state. If the measured value of the amount of data transfer is above the threshold Ta in the idle transition state, the memory controller 10 transitions to the active control state. If the measured value of the amount of data transfer is continuously below the threshold Tb in the idle transition state, the memory controller 10 transitions to the idle control state.

The idle transition state is provided to prevent the state from frequently transitioning between the active control state and the idle control state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host, the memory system comprising:
a nonvolatile first memory; and
a controller circuit that controls to transfer data between the host and the first memory,
wherein the controller circuit
measures a rate of data transfer between the host and the memory system,
calculates a first level which is a performance level corresponding to a processing capability of the host, on the basis of the measured rate, and
operates in a first mode of controlling performance of the data transfer at the first level.

2. The memory system according to claim 1, wherein the controller circuit sets, as the first level, a value which is lower than maximum performance of the data transfer of the memory system and is greater than the measured rate.

3. The memory system according to claim 1, wherein
in the first mode, the controller circuit measures the rate of the data transfer and transitions to a second mode on the basis of a comparison between the measured rate and a first threshold, and
in the second mode, the controller circuit controls the performance of the data transfer at a second level which is a minimum value within a settable range and is lower than the first level.

4. The memory system according to claim 3, wherein in the second mode, the controller circuit measures the rate of the data transfer and transitions to the first mode on the basis of a comparison between the measured rate and a second threshold which is greater than the first threshold.

5. The memory system according to claim 3, wherein
in the first mode, the controller circuit measures the rate of the data transfer and transitions to a third mode in a case where the measured rate is below a second threshold which is greater than the first threshold,
in the third mode, the controller circuit measures the rate of the data transfer, and the controller circuit transitions to the first mode in a case where the measured rate is above the second threshold, and transitions to the second mode in a case where the measured rate is continuously below the first threshold.

6. The memory system according to claim 2, wherein the controller circuit measures the rate a plurality of times at different timings, acquires a measured value of the rate in each measurement, and sets, as the first level, a value which is greater than a maximum value of the plurality of measured values obtained by the plurality of measurements.

7. The memory system according to claim 6, further comprising a second memory, wherein, in each measurement, the controller circuit:
records a measured value of the rate in the second memory in a case where the measured value is above a first threshold;
does not record the measured value of the rate in the second memory in a case where the measured value is below the first threshold; and
sets, as the first level, a value which is greater than a maximum value of one or more measured values recorded.

8. The memory system according to claim 7, wherein the controller circuit multiplies the maximum value by a constant greater than one, and sets a value obtained by the multiplication, as the first level.

9. The memory system according to claim 1, wherein
the first memory includes a plurality of memory chips, and
the controller circuit controls a number of memory chips to access in parallel among the plurality of memory chips to control the performance of the data transfer at the first level.

10. The memory system according to claim 1, wherein the controller circuit controls a frequency of a clock that drives the first memory or the controller circuit to control the performance of the data transfer at the first level.

11. A method of controlling data transfer between a memory system including a nonvolatile first memory and a host, the method comprising:
measuring a rate of the data transfer between the host and the memory system;
calculating a first level which is a performance level corresponding to a processing capability of the host, on the basis of the measured rate; and
controlling performance of the data transfer at the first level in a first mode.

12. The method according to claim 11, further comprising setting, as the first level, a value which is lower than maximum performance of the data transfer of the memory system and is greater than the measured rate.

13. The method according to claim 11, further comprising:
measuring the rate of the data transfer,
transitioning from the first mode to a second mode on the basis of a comparison between the measured rate and a first threshold; and
controlling, in the second mode, the performance of the data transfer at a second level which is lower than the first level and be a minimum value within a settable range.

14. The method according to claim 13, further comprising
measuring the rate of the data transfer; and
transitioning from the second mode to the first mode on the basis of a comparison between the measured rate and a second threshold which is greater than the first threshold.

15. The method according to claim 13, further comprising:
measuring, in the first mode, the rate of the data transfer;
transitioning from the first mode to a third mode in a case where the measured rate is below a second threshold which is greater than the first threshold;
measuring, in the third mode, the rate of the data transfer;
transitioning from the third mode to the first mode in a case where the measured rate is above the second threshold; and
transitioning from the third mode to the second mode in a case where the measured rate is continuously below the first threshold.

16. The method according to claim 12, further comprising:
measuring the rate a plurality of times at different timings;
acquiring a measured value of the rate in each measurement; and
setting, as the first level, a value which is greater than a maximum value of the plurality of measured values obtained by the plurality of measurements.

17. The method according to claim 16, further comprising:
recording a measured value of the rate in a second memory in a case where the measured value is above a first threshold;
not recording the measured value of the rate in the second memory in a case where the measured value is below the first threshold; and
setting, as the first level, a value which is greater than a maximum value of one or more measured values recorded in the second memory.

18. The method according to claim 17, further comprising multiplying the maximum value by a constant which is greater than one, and setting a value obtained by the multiplication, as the first level.

19. The method according to claim 11,
wherein the first memory includes a plurality of memory chips and
the method further comprises controlling a number of memory chips to access in parallel among the plurality of memory chips to control the performance of the data transfer at the first level.

20. The method according to claim 11, further comprising controlling a frequency of a clock to control the performance of the data transfer at the first level.
